(19) United States
(12) Patent Application Publication
(10) Pub. No.: US 2026/0274253 A1
(43) Pub. Date: Sep. 17, 2026

(54) Method and Device for Adjusting an Operating State of a Driver Assistance System

(71) Applicant: Bayerische Motoren Werke Aktiengesellschaft, Muenchen (DE)

(72) Inventors: Ivo NIKOLOV, Muenchen (DE); Christoph RESCH, Obernzell (DE)

(21) Appl. No.: 18/872,202

(22) PCT Filed: Jun. 2, 2023
(86) PCT No.: PCT/EP2023/064769

§ 371 Date: Dec. 5, 2024

(30) Foreign Application Priority Data
Jun. 8, 2022 (DE) 10 2022 114 449.6

(51) Int. Cl. B60W 30/12; G06V 20/56

(52) U.S. Cl. CPC B60W 30/12; G06V 20/588; B60W 2420/403; B60W 2552/53; B60W 2555/20

(57) ABSTRACT

A method adjusts an operating state of a driver assistance system that is configured to control a lateral guidance of a motor vehicle based on image data recorded using a camera of the motor vehicle. Weather conditions in the surroundings of the motor vehicle are determined and a lane marking is recognized, based on the image data. A length of the recognized lane marking is determined, and the operating state of the driver assistance system is adjusted based on the determined weather conditions and the determined length of the recognized lane marking.

### BACKGROUND AND SUMMARY

The present disclosure relates to a method for adjusting an operating state of a driver assistance system, which is designed to control a lateral guidance of a motor vehicle based on image data recorded using a camera of the motor vehicle. Additionally or alternatively, a data processing device is provided, which is designed to at least partially carry out the method. Additionally or alternatively, a motor vehicle which at least partially comprises the data processing device is provided. Additionally or alternatively, a computer program is provided, which comprises commands that, upon the execution of the program by a computer, prompt it to at least partially carry out the method. Additionally or alternatively, a computer-readable medium is provided, which comprises commands that, upon the execution of the commands by a computer, prompt it to at least partially carry out the method.

Current lateral guidance systems are based above all on lane information which is recorded based on sensor data of a front camera of the motor vehicle.

DE 4124654 A1 describes in this context a method for continuous and automatic vehicle orientation on a roadway using an image-generating system and computerized image evaluation to generate vehicle control data, wherein the image data of a last monocularly generated image of a progressive image sequence are modeled with the aid of a program controlling an electronic computer, oriented on spatial-geometric and temporal-dynamic aspects of a scene, in order to then use them by means of recursive estimation methods for determining the road parameters, especially the horizontal and vertical curvature course in the forecast area and the width and its own road-related situation.

A recognition quality of the front camera sometimes decreases significantly in bad weather, however (e.g., in fog, low-lying sun, snow, rain, etc.).

To avoid errors in the lateral guidance, attempts are therefore made to recognize bad weather and switch off the lateral guidance system early. This is required above all with so-called hands-off systems (in the case of which the driver at least does not have to have the hands permanently on the steering wheel), because particularly here the requirements for the performance of the lateral guidance are often higher than with so-called hands-on systems (in the case of which the driver at least does not have to have the hands permanently on the steering wheel).

The bad weather is recognized in two ways via the same front camera, the data of which are also used as the input variables for the lateral guidance. On the one hand, the bad weather is recognized from the image data themselves. Alternatively, the bad weather is recognized from the running length of the recognized lane markings, which can be used as input data for the lateral guidance.

Current systems only use one of the abovementioned recognition methods, wherein each method has its disadvantages.

The recognition of the bad weather from the image data themselves can result in too early or too late recognition of bad weather conditions, since the recognition claims a certain amount of time. Moreover, an erroneous recognition can take place due to incorrect image data/incorrect image interpretations.

The recognition of the bad weather from the running length of the recognized lane markings can have the disadvantage that the running length can be restricted even with good weather because the lane markings are poorly visible. In this case, incorrect switching off of the function occurs.

Against the background of this prior art, the object of the present disclosure is to specify a device and a method which are each suitable for enhancing at least the abovementioned prior art.

The object is achieved by the features of the independent claim. Preferred refinements of the invention are the content of the dependent claims.

Accordingly, the object is achieved by a method for adjusting an operating state of a driver assistance system which is designed to control a lateral guidance of a motor vehicle based on image data recorded using a camera of the motor vehicle.

The method can be a computer-implemented method, i.e. one, multiple, or all steps of the method can be carried out by means of a computer or a data processing device.

The driver assistance system is an automated driving function, which can be understood as a function of the motor vehicle designed to at least temporarily take over certain parts of or even the entire driving task, possibly together with further automated driving functions.

The driver assistance system is a system having hardware and/or software components which receive as input data the image data and/or information generated based on the image data, process these in a predetermined manner and thus generate a control signal, which is output to the motor vehicle in order to control the lateral guidance.

Depending on the degree of automation of the motor vehicle, the control of the lateral guidance can comprise active and/or passive interventions in the lateral guidance of the motor vehicle by means of the driver assistance system. The motor vehicle can also be designed to control a longitudinal guidance of the motor vehicle by means of the and/or a further driver assistance system. This can also be carried out based on the image data.

The method comprises determining weather conditions in the surroundings of the motor vehicle based on the image data.

The weather conditions can be understood as the weather and/or optionally its change in the surroundings or an environment of predetermined size of the motor vehicle. Examples of weather conditions comprise a brightness (for example, caused by the sun and/or oncoming vehicles, etc.) and/or a precipitation (e.g., rain, snow, and/or fog, etc.).

The method comprises recognizing a lane marking based on the image data and determining a length of the recognized lane marking.

The lane marking can also be designated as a roadway marking. It is usually a colored identification (for example, white or yellow) on a surface of traffic surfaces of the road traffic, i.e. the road, on which the motor vehicle is located at the time the method is carried out. In the present case, in particular so-called longitudinal markings can be used. Longitudinal markings are arranged longitudinally in relation to or along a travel direction. They largely take over the optical guidance of the road user.

An object recognition algorithm can be used to recognize the lane marking.

The method comprises adjusting the operating state of the driver assistance system based on the determined weather conditions and the determined length of the recognized lane marking.

Adjusting the operating state can also be referred to as controlling the operating state and can comprise the output of a control signal to the driver assistance system.

Possible refinements of the method are described in detail hereinafter.

Adjusting the operating state of the driver assistance system can comprise deactivating or preventing activation of the driver assistance system. In other words, depending on whether or not the driver assistance system is active at the time of the adjustment of the operating state, which was determined based on the image data, the driver assistance system can either be activatable or remain active or the driver assistance system can either be deactivated or be not activatable. Active in this case means that the driver assistance system controls the lateral guidance. In contrast, deactivated means that the driver assistance system does not control the lateral guidance.

The deactivation or the prevention of the activation of the driver assistance system can take place if the determined length of the recognized lane marking falls below a predetermined threshold value and the determined weather conditions meet a predetermined criterion of bad weather conditions (for example, precipitation exceeds a predetermined limiting value).

The method can comprise controlling the lateral guidance of the motor vehicle by means of the driver assistance system based on the image data in dependence on the adjusted operating state of the driver assistance system.

The control of the lateral guidance of the motor vehicle can be carried out based on a course of the recognized lane marking. Interventions in the lateral guidance can be carried out so that the motor vehicle follows a trajectory which extends substantially parallel to the lane marking. A trajectory can be understood as a path along which the motor vehicle is supposed to drive (so-called target trajectory) or actually drives (so-called actual trajectory). In addition to position specifications, the trajectory can also have a time component, i.e. when the motor vehicle is supposed to be or is where.

The determination of the weather conditions and/or the recognition and/or determination of the length of the lane marking can be carried out by the camera. That is to say, the camera may not output the image data themselves, for example, but rather the type or category of the weather conditions (such as “bad weather”), the course of the lane marking and/or a course of a roadway center determined based thereon, and/or a length of the course of the lane marking. These can then be used as input data for the method. However, it is also conceivable, additionally or alternatively, that the camera itself carries out the complete method.

The description above can be summarized as follows in other words and with respect to a specific embodiment, which is described hereinafter as not limiting for the disclosure.

The two recognition principles mentioned at the outset can be combined, so that a recognition of the bad weather from the image data themselves and a recognition of the bad weather from the running length of the recognized lane markings (which can be used as input data for the lateral guidance) take place.

Bad weather can be recognized if both abovementioned conditions are met simultaneously.

If the bad weather is recognized via this method, the lateral guidance system can be switched off.

More reliable recognition of bad weather thus results and unauthorized shutdowns of the lateral guidance function occur more rarely.

Furthermore, a device for data processing is provided which comprises means for carrying out the above-described method. The device for data processing can also be referred to as a system for data processing or as a data processing device. More precisely, the system for data processing has a camera and a control device connected to the camera.

The system for data processing can be designed to be at least partially installed in and/or on an automated motor vehicle and/or to be at least partially part of a cloud.

The system for data processing can be part of the driver assistance system or an automated driving function or can represent and/or execute it. The system for data processing can have an electronic control unit (ECU). The data processing device can have an intelligent processor-controlled unit which can communicate, for example, via a central gateway (CGW) with other modules and which can possibly form the vehicle onboard network via field buses, such as the CAN bus, LIN bus, MOST bus, and FlexRay or via automotive ethernet, for example, together with telematics control units. It is conceivable that the control unit controls functions relevant for the driving behavior of the motor vehicle, such as the motor control, the force transmission, the braking system, and/or the tire pressure monitoring system. In addition, driver assistance systems, such as a parking assistant, an adaptive cruise control (ACC), a lane keeping assistant, a lane changing assistant, a traffic sign recognition function, a traffic signal recognition function, a starting assistant, a night vision assistant, an emergency braking assistant, and/or an intersection assistant, can be controlled by the control unit.

It is conceivable that the system for data processing at least partially and/or temporarily controls automated driving of the automated motor vehicle based on an output of the surroundings model.

The description above with respect to the method also applies analogously to the system for data processing and vice versa.

Furthermore, an automated motor vehicle can be provided, which has the above-described system for data processing.

The motor vehicle can be a passenger vehicle, in particular an automobile.

The automated motor vehicle can be designed to at least partially and/or at least temporarily take over longitudinal guidance and/or lateral guidance by means of the automated driving function during automated driving of the motor vehicle. The automated driving can be at least partially and/or temporarily controlled by the data processing device by means of the automated driving function.

The automated driving can take place so that the forward movement of the motor vehicle takes place (substantially) autonomously.

The motor vehicle can be a motor vehicle of autonomy level 0, i.e. the driver takes over the dynamic driving task, even if assisting systems (such as ABS or ESP) are present.

The motor vehicle can be a motor vehicle of autonomy level 1, i.e. can have specific driver assistance systems which assist the driver in the vehicle operation, such as the adaptive cruise control (ACC).

The motor vehicle can be a motor vehicle of autonomy level 2, i.e. partially automated so that functions such as automatic parking, lane keeping or lateral guidance, general longitudinal guidance, acceleration, and/or deceleration are taken over by driver assistance systems.

The motor vehicle can be a motor vehicle of autonomy level 3, i.e. conditionally automated so that the driver does not have to continuously monitor the system of the vehicle. The motor vehicle independently carries out functions such as triggering the turn signal, lane changing, and/or lane keeping. The driver can address other things but will be prompted by the system if needed within a prewarning time to take over the guidance.

The motor vehicle can be a motor vehicle of autonomy level 4, i.e. so highly automated that the guidance of the vehicle is permanently taken over by the system of the vehicle. If the driving tasks are no longer managed by the system, the driver can be prompted to take over the guidance.

The motor vehicle can be a motor vehicle of autonomy level 5, i.e. so fully automated that the driver is not necessary to fulfill the driving task. Except for defining the destination and starting the system, no human intervention is necessary.

The description above with reference to the methods and the system for data processing also applies analogously in each case to the motor vehicle and vice versa.

Furthermore, a computer program is provided. The computer program is distinguished in that it comprises commands which, upon the execution of the program by a computer, prompt it to at least partially carry out the described method.

A program code of the computer program can be provided in any code, in particular in a code which is suitable for controllers of motor vehicles.

Furthermore, a computer-readable medium is provided, in particular a computer-readable storage medium. The computer-readable medium is distinguished in that it comprises commands which, upon the execution of the program by a computer, prompt it to at least partially carry out the above-described method.

That is to say, a computer-readable medium can be provided which comprises an above-defined computer program. The computer-readable medium can be any digital data storage device, such as a USB stick, a hard drive, a CD-ROM, an SD card, or an SSD card. The computer program does not necessarily have to be stored on such a computer-readable storage medium in order to be provided to the motor vehicle, but rather can also be externally acquired via the Internet or in another way.

The description above with respect to the methods, the system for data processing, and the automated motor vehicle also applies analogously in each case to the computer program and the computer-readable medium and vice versa.

An embodiment is described hereinafter with reference to FIGS. 1 and 2.

### BRIEF DESCRIPTION OF THE DRAWINGS

FIG. 1 schematically shows a motor vehicle in a top view, which is designed to carry out a method for adjusting an operating state of a driver assistance system, and

FIG. 2 schematically shows a flow chart of the method.

### DETAILED DESCRIPTION OF THE DRAWINGS

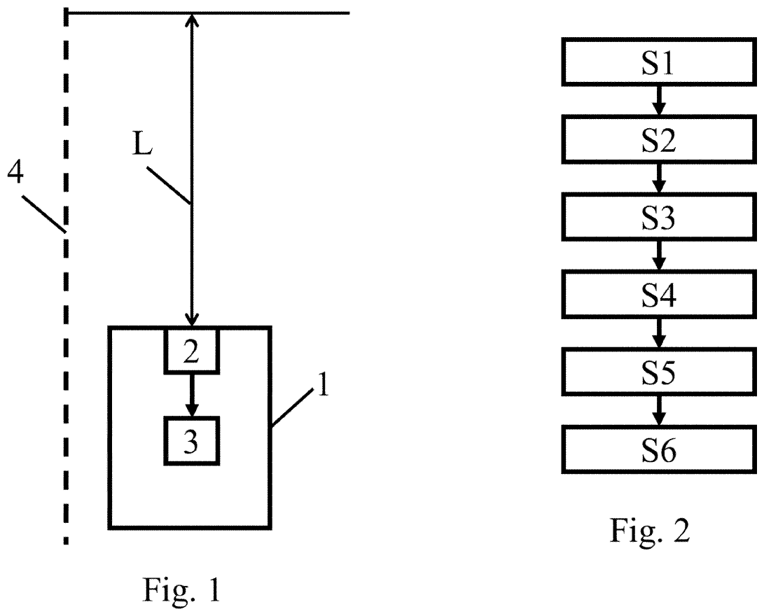

The motor vehicle 1 shown in FIG. 1 has a surroundings camera 2, a front camera here, which is connected to a control unit 3. The (surroundings) camera 2 and the control unit 3 together form at least a part of a system for data processing, which is designed to carry out the method for adjusting the operating state of the driver assistance system, the flow chart of which is shown in FIG. 2. The control unit 3 itself is at least part of the driver assistance system here and is designed to control a lateral guidance of the motor vehicle 1 based on image data recorded using the camera 2 of the motor vehicle 1.

As shown in FIG. 2, the method essentially comprises six steps S1-S6.

In a step S1 of the method, weather conditions in the surroundings of the motor vehicle are determined by means of the camera based on the image data, which are recorded by the camera 2 in an optional initial step of the method (not shown in FIG. 2).

In a second step S2 of the method, a lane marking 4 in the surroundings of the motor vehicle 1 is recognized and a course thereof is determined based on the image data by means of the camera 2, wherein the first and second steps S1, S2 can run at least partially/temporarily in parallel.

That is to say, in steps S1 and S2, the camera 2 recognizes, for example, “heavy rain” via a weather algorithm as bad weather conditions. At the same time, the same camera 2 outputs the course of the lane marking 4, for example, in the form of a polynomial or in the form of a polyline (or a spline).

In a third step S3 of the method, the determined weather conditions, i.e. in the present case either good or bad weather conditions, and the determined course of the lane marking 4 are output by the camera 2 to the control unit 3.

In a fourth step S4 of the method, the control unit 3 determines a length L of the recognized lane marking 4 based on the course of the lane marking 4.

In a fifth step S5 of the method, the operating state of the driver assistance system is adjusted by means of the control unit 3 based on the determined weather conditions and the determined length L of the recognized lane marking 4. The adjustment of the operating state of the driver assistance system comprises deactivating or preventing an activation of the driver assistance system if the determined length L of the recognized lane marking 4 falls below a predetermined threshold value and bad weather conditions exist.

A scenario is conceivable here, for example, in which with good weather and well visible lane markings, a running length L of the lane marking 4 (and thus the distance or length L up to which the camera 2 recognizes the lane markings) is at 80 m, for example. With bad weather and/or with bad lane markings, the running length L of the lane marking 4 in contrast can only be, for example, 20 m. Early deactivation of the automated lateral guidance can then take place, for example, according to the following table:

| | | | Operating state to be |
|---|---|---|---|
| Case | Weather conditions | Length | adjusted |
| 1 | bad weather | 80 m | active or activatable |
| 2 | bad weather | 20 m | deactivated or not |
| | | | activatable |
| 3 | good weather | 80 m | active or activatable |
| 4 | good weather | 20 m | active or activatable |

In above cases 1, 3, and 4 and with active driver assistance system, in a sixth step S6 of the method, a control of the lateral guidance of the motor vehicle 1 is carried out by means of the driver assistance system by the control unit 3 based on the image data, wherein the lateral guidance of the motor vehicle 1 is controlled in particular based on the course of the recognized lane marking 4.

### LIST OF REFERENCE SIGNS

1 motor vehicle
2 camera
3 control unit or control device
4 lane marking
L length
S1-S6 steps of the method

1-10. (canceled)

11. A method for adjusting an operating state of a driver assistance system, wherein the driver assistance system is configured to control a lateral guidance of a motor vehicle based on image data recorded using a camera of the motor vehicle, the method comprising:
determining weather conditions in the surroundings of the motor vehicle based on the image data;
recognizing a lane marking based on the image data;
determining a length of the recognized lane marking; and
adjusting the operating state of the driver assistance system based on the determined weather conditions and the determined length of the recognized lane marking.

12. The method of claim 11, wherein the adjustment of the operating state of the driver assistance system comprises deactivating or preventing activation of the driver assistance system.

13. The method of claim 12, wherein the deactivation or the prevention of the activation of the driver assistance system takes place when the determined length of the recognized lane marking falls below a predetermined threshold value and the determined weather conditions meet a predetermined criterion of bad weather conditions.

14. The method of claim 11, further comprising:
controlling the lateral guidance of the motor vehicle by means of the driver assistance system based on the image data in dependence on the adjusted operating state of the driver assistance system.

15. The method of claim 14, wherein the lateral guidance of the motor vehicle is controlled based on a course of the recognized lane marking.

16. The method of claim 11, wherein the determination of the weather conditions and/or the recognition and/or determination of the length of the lane marking is carried out by the camera.

17. A system for data processing, comprising:
a camera; and
a control device connected to the camera,
wherein the system is configured to execute the method of claim 11.

18. A motor vehicle, comprising:
a system configured to execute the method of claim 11, wherein the system includes: a camera, and a control device connected to the camera, and
wherein the motor vehicle is configured to control the lateral guidance based on the image data recorded using the camera.

19. A non-transitory computer-readable medium storing executable instructions that, when executed by a computer, cause the computer to perform the method of claim 11.
